(19) United States
(12) Patent Application Publication
(10) Pub. No.: US 2025/0139590 A1
(43) Pub. Date: May 1, 2025

(54) GENERATIVE ARTIFICIAL INTELLIGENCE (AI) FOR HOME MAINTENANCE ALERTS AND REPAIR AUTOMATION

(71) Applicant: State Farm Mutual Automobile Insurance Company, Bloomington, IL (US)

(72) Inventors: Andrew T. Swartz, Mesa, AZ (US); Aaron Williams, Congerville, IL (US)

(21) Appl. No.: 18/745,328

(22) Filed: Jun. 17, 2024

Related U.S. Application Data
(60) Provisional application No. 63/594,519, filed on Oct. 31, 2023.
(60) Provisional application No. 63/612,163, filed on Dec. 19, 2023.

(51) Int. Cl. G06Q 10/20

(52) U.S. Cl. CPC G06Q 10/20

(57) ABSTRACT

An electronic device to automate home maintenance alerts and repair work is disclosed. The device includes a processor programmed to: (i) receive data associated with an appliance and corresponding to a measurement of one or more aspects related to a functioning of the appliance; (ii) determine an issue causing the appliance to improperly function by analyzing the received data; (iii) identify a part for the appliance to address the improper functioning of the appliance; (iv) generate an alert identifying: a description of the appliance that is improperly functioning, the part identified to address the improper functioning of the appliance, and/or a skill level required to fix the issue; (v) in response to an input from a stakeholder, generate recommendations including proposed fixes to address the issue; and/or (vi) in response to an election by the stakeholder of a recommendation from the recommendations, generate additional outputs to address fixing the issue.

### CROSS-REFERENCE TO RELATED APPLICATIONS

This application claims priority to U.S. Provisional Patent Application No. 63/594,519, filed Oct. 31, 2023, entitled “Generative Artificial Intelligence (AI) for Home Maintenance Alerts and Repair Automation,” and U.S. Provisional Patent Application No. 63/612, 163, filed Dec. 19, 2023, entitled “Generative Artificial Intelligence (AI) for Home Maintenance Alerts and Repair Automation,” the entire contents of which are hereby incorporated herein by reference in their entirety.

### FIELD OF THE DISCLOSURE

The present disclosure generally relates to automation of home maintenance alerts and repair work, and, more particularly, to methods and systems for using generative artificial intelligence in automation for generating home maintenance alerts and performing repair work.

### BACKGROUND

Many homeowners may not have the required expertise for resolving issues related to various home appliances, performing timely maintenance of home appliances, or other types of work or issues at home (e.g., electrical, mechanical, plumbing, and/or heating, ventilation, and air conditioning (HVAC)). To resolve these issues, a homeowner may depend on the expertise and experience of other persons. In many cases, the other person may recommend a fix or a solution that may not be the most appropriate from one or more aspects. For example, the fix or the solution may be too costly, or may not provide a durable and/or a long-term solution for the issue.

Accordingly, there exists a need for a system, which can identify and alert a homeowner to timely maintenance of various home appliances and/or other electrical, mechanical, plumbing, and/or HVAC systems. The system may also provide appropriate solutions to fix a particular issue. Conventional techniques may include additional inefficiencies, encumbrances, ineffectiveness, and/or other drawbacks as well.

### BRIEF SUMMARY

The present embodiments may relate to, inter alia, a system that (i) identifies when a problem arises in a home appliance, an electrical or a mechanical system, a plumbing system, and/or an HVAC system, and (ii) alerts a user about the problem, and also (iii) recommends what may be an appropriate solution to fix the problem from various aspects such as cost, effectiveness, and so on. The present systems and methods may further include a plurality of models trained to recognize issues relating to items, fixtures, appliances, and/or features at properties from sensor data, where the sensor data is analyzed to determine any potential issues with the items, fixtures, appliances, and/or features.

In one aspect, a computer system for the automation of home maintenance alerts and repair work may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one memory and at least one processor in communication with the at least one memory. The at least one processor may be programmed to: (i) receive data from an appliance, the data corresponding to a measurement of one or more aspects related to a functioning of the appliance; (ii) determine an issue causing the appliance to improperly function by analyzing the received data associated with the appliance; (iii) identify a part for the appliance to address the improper functioning of the appliance; (iv) generate and transmit an alert to a stakeholder, the alert identifying at least one of: a description of the appliance that is improperly functioning, the part identified to address the improper functioning of the appliance, and a skill level required to fix the issue associated with the appliance; (v) in response to an input from the stakeholder, generate one or more recommendations including proposed fixes to address the issue; and/or (vi) in response to an election by the stakeholder of a recommendation from the one or more recommendations, generate additional outputs to address fixing the issue. The computer system may include additional, less, or alternate functionality, including that discussed elsewhere herein.

In another aspect, a computer-implemented method for identifying an issue with an appliance or system may be provided. The computer-implemented method may be performed or implemented by a computing device including at least one processor in communication with at least one memory device. The method may include: (i) receiving data from the appliance or system, the data corresponding to a measurement of one or more aspects related to the functioning of the appliance or system; (ii) based upon the received data, determining that the appliance or system is improperly functioning; (iii) based upon the received data, identifying a part associated with the improper functioning of the appliance or system; (iv) generating and transmitting an alert to a stakeholder, the alert identifying at least one of: a description of the appliance or system that is improperly functioning, the part associated with the improper functioning of the appliance or system, and a skill level required to fix the improperly functioning of the appliance or system; (v) in response to an input from the stakeholder, generating one or more recommendations including proposed fixes to the appliance or system; and/or (vi) in response to an election by the stakeholder of a recommendation from the one or more recommendations, performing additional steps to facilitate fixing the improperly functioning application or system. The computer-implemented method may include additional, less, or alternate actions, including those discussed elsewhere herein.

In yet another aspect, at least one non-transitory computer-readable storage media having computer-executable instructions stored thereon may be provided. The instructions wen executed by a computing device including at least one processor and at least one memory device cause the at least one processor to: (i) receive inputs corresponding to an issue related to an appliance or system, the inputs including at least one of: audio data, video data, or text data; (ii) determine that the appliance or system is improperly functioning based on the received inputs; (iii) identify an issue with the improperly functioning appliance or system including a part associated with the improperly functioning appliance or system that requires replacing or repairing; (iv) present one or more recommendations to a user including options to fix the issue with the improperly functioning appliance or system; and/or (v) in response to an election by the user of a recommendation from the one or more recommendations, provide additional information to facilitate fixing the issue with the improperly functioning appliance or system. The computer-executable instruction may cause additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed herein. However, it should be understood that the present embodiments are not limited to the precise arrangements and/or instrumentalities shown herein.

FIG. 1 depicts an exemplary configuration of a generative artificial intelligence-based home maintenance system, in accordance with one embodiment of the present disclosure.

FIG. 2 depicts an exemplary configuration of a master controller unit, a user device or a user equipment for use with the home maintenance system shown in FIG. 1, in accordance with one embodiment of the present disclosure.

FIG. 3 depicts an exemplary configuration of an application server for use with the home maintenance system shown in FIG. 1, in accordance with one embodiment of the present disclosure.

FIG. 4 depicts a flow-chart of exemplary computer-implemented method operations for generating and transmitting a home maintenance alert and assisting the homeowner or the stakeholder to have a problem fixed, in accordance with one embodiment of the present disclosure.

FIG. 5 depicts another flow-chart of exemplary computer-implemented method operations for assisting the homeowner or the stakeholder in having a problem fixed, in accordance with one embodiment of the present disclosure.

FIGS. 6A-6D depict a flow-chart of exemplary operations for assisting the homeowner or the stakeholder in having a problem fixed, in accordance with one embodiment of the present disclosure.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, a network-based system and method that uses artificial intelligence tools to identify a problem that arises in a home appliance, an electrical or a mechanical system, a plumbing system, and/or an HVAC system; transmits alerts about the problem to a user; and recommends solutions to resolve the problem from various aspects such as cost, effectiveness, and durability.

As described herein, many homeowners may not have the required expertise when issues related to various home appliances occur. The homeowners may also have difficulty performing timely maintenance of home appliances or other types of work or issues at home (e.g., electrical, mechanical, plumbing, and/or heating, ventilation, and air conditioning (HVAC)). For example, when an air conditioning (AC) unit stops working, whether the AC unit just needs a clean-up, a tuning, a freon refill, and/or a complete AC replacement, may be unknown to a homeowner. The homeowner may then be at the mercy of one or more technicians who may have a very different understanding about the problem and how to fix the problem. Depending on their expertise and experience level, each technician may take different amount of time to fix the problem and may result in a final bill which may vary significantly from one technician to another. The embodiments of systems and methods described in the present disclosure may assist the homeowner to identify what is an actual problem. Based upon the homeowner's expertise and comfort level, the system may recommend whether the problem is easy enough to be fixed by the homeowner or if a professional service provider is required to fix or resolve the problem.

In some embodiments, various appliances that are installed in a home, or an office, may have one or more sensors, which may generate data corresponding to one or more measured parameters and transmit the generated data to a master controller unit. By way of a non-limiting example, the data may be generated and transmitted to the master controller unit periodically or upon meeting a specific condition. For example, a thermostat controller device including a computing device (or a processor) may transmit data, collected by a temperature sensor, to the master controller unit when the thermostat controller device may detect that a desired temperature change has not occurred even though an AC unit is set on a particular cooling or heating mode, and that the AC unit has been on for a substantial time to make the desired temperature change. The data transmitted to the master controller unit by the thermostat controller device may include a value for the current temperature and/or a value of the set temperature. The data transmitted to the master controller unit may also include a time since the AC unit is set on a particular cooling or heating mode. Additionally, or alternatively, the data may be transmitted to the master controller unit periodically or upon meeting a certain condition, such as upon detecting that the desired temperature change has not occurred in a specific time period.

While the AC unit and a problem with the AC unit are described in the present disclosure as an example only, different appliances may have a different set of one or more sensors to monitor proper functioning of the appliance. Similarly, various issues or problems associated with an electrical system, a mechanical system, a plumbing system, and/or an HVAC system may be detected based upon data collected and transmitted to the master controller unit. As described herein, the data may be transmitted to the master controller unit periodically or upon meeting a certain condition.

The data may be collected at an appliance using at least one sensor, which may be specific for the appliance. Similarly, the data may be collected from an electrical system, a mechanical system, a plumbing system, and/or an HVAC system using a respective set of at least one sensor. By way of a non-limiting example, the at least one sensor of the respective set may include, but is not limited to, a temperature sensor, a lux sensor (or a light level sensor), a water level sensor, an air composition sensor, an image sensor, a voice/sound sensor, a pressure sensor, a humidity sensor, an accelerometer, an infrared sensor, a vibration sensor, and/or an ultrasonic sensor.

Based upon the data collected using the at least one sensor, the system may determine whether each appliance, and/or an electrical/mechanical/plumbing/HVAC system is working properly or has some problem. In response to determining that there is a problem, the collected data and/or a list of possible issues may be transmitted to a master controller unit. Additionally, or alternatively, based upon the data received at the master controller unit, the master controller unit may identify a list of possible issues. The master controller unit may then alert one or more stakeholders (e.g., a homeowner, and/or a property manager). The alert may be transmitted as a text message, an email, a phone call, and/or a notification pushed to a mobile application.

The master controller unit may be a processor, an Internet-of-Things (IOT) device, voice or chat bot, ChatGPT or ChatGPT-based bot, or an electronic device that uses artificial intelligence and/or machine-learning to determine or identify (i) a list of one or more problems that are required to be fixed; (ii) a list of one or more parts or functions to be inspected, for example, to confirm, to narrow the list of problems, or to identify additional problems to fix or resolve the one or more problems; and/or (iii) a list of one or more parts required to be repaired or replaced to fix the one or more problems. The master controller unit may also provide details of the one or more problems that have been identified based upon the received data, and details about how each of the one or more identified problems may be fixed (e.g., the list of one or more parts of functions to be inspected, the list of one or more parts required to be repaired or replaced) in the alert transmitted to the one or more stakeholders. The alert may include a short link, which may be selectable by the one or more stakeholders.

In some embodiments, when the one or more stakeholders select the short link, or access details of a particular problem identified by the master controller unit, including the details of the problem, how the problem may be fixed, and/or a particular skill level required for fixing the problem. In some embodiments, based upon the skill level (or a rating or a grade) required to inspect, confirm, and/or repair or replace one or more parts to fix or resolve the problem, the master controller unit may recommend whether the problem should be fixed by a professional service provider and/or whether the problem may be fixed by the stakeholder. In some embodiments, one or more questions may be presented to a user (the stakeholder), and based upon user inputs to the one or more questions, the master controller unit may recommend whether it would be better to have the problem fixed by a professional service provider or the user themselves. Based upon the recommendation by the master controller unit, and received confirmation of a particular method (e.g., fixing by a professional service provider, fixing by the stakeholder, and/or a mix) to fix the problem, the master controller unit may assist in getting the problem fixed in different ways.

By way of a non-limiting example, if the stakeholder selects or elects that the problem be fixed by a professional service provider, the master controller unit may identify one or more professional service providers that may be available to fix the problem. The one or more professional service providers may be selected by the master controller unit based upon criteria including, but not limited to, ratings of each professional service provider, experience of each professional service provider, estimated time required to fix the problem, rates (hourly or fixed) charged by each professional service provider, availability of each professional service provider, an urgency or criticality of the problem to be fixed, reviews and feedback provided by other customers for a professional service provider, user preferences, and/or any other criteria desired. In some cases, the master controller unit may be in communication with the professional service providers' computing devices, and thus, it is able to determine scheduling availability and is able to then schedule the time for repair and/or inspection.

The master controller unit may include a communication interface, and the master controller unit may form a query (for example, a free form text query or a natural language process query) and transmit to a server using the communication interface coupling the master controller unit to the server over a local area network, a wide area network, a 3G network, a 4G network, a 5G network, a 6G network, a satellite network, and/or an Internet.

In some embodiments, based upon the responses received by the master controller unit in response to the query, the master controller unit may generate a ranking score for each professional service provider identified from the query responses. In some embodiments, the ranking score for each professional service provider may be determined in accordance with a respective weight assigned to each aspect of criteria including, but not limited to, ratings of each professional service provider, experience of each professional service provider, estimated time required to fix the problem, rates (hourly or fixed) charged by each professional service provider, availability of each professional service provider, an urgency or criticality of the problem to be fixed, reviews and feedback provided by other customers for a professional service provider, user preferences, and/or any other criteria desired. The ranking score may identify a preferred or a recommended professional service provider by the master controller unit. A higher value of the ranking score may indicate the professional service provider is a preferred professional service provider to fix the problem.

Based upon the ranking score determined for each professional service provider, the master controller unit may display one or more professional service providers having a ranking score above a specific threshold value (e.g., a ranking score above 80% or 75%) to the user. The master controller unit may also display a respective ranking score of the one or more professional service providers displayed to the user. Further, the one or more professional service providers may be displayed as a sorted list that may be alphabetically sorted by a name of the professional service provider and/or sorted by the ranking score in an ascending order or a descending order. Alternatively, the master controller unit may display one or more professional service providers without the ranking score.

In some embodiments, upon receiving an input from the user and corresponding to a selection of one or more professional service providers from the displayed one or more professional service providers having a ranking score above the specific threshold value, the master controller unit may automatically contact the one or more selected professional service providers. The master controller unit may contact the one or more selected professional service provider based upon contact information identified from the received responses for the query transmitted by the master controller unit. The master controller unit may include details about the identified problem including, but not limited to, description of the problem, an urgency or a criticality of the problem, one or more particular parts identified for repair or replacement, and/or a budget, etc.

Upon receiving a response from the contacted one or more selected professional service providers, if the response includes a quote from professional service provider, the master controller unit may display the quote to the user. Additionally, or alternatively, upon receiving responses from each contacted professional service providers, or a certain number of professional service providers, or after waiting a predetermined period to receive responses from the contacted professional service providers, the master controller unit may display all received responses to the user. By way of an example, the master controller unit may display the received response based upon the received quote from the professional. For example, the professional service provider who suggested the lowest quote may be displayed on the top followed by other professional service providers with their suggested quotes in an ascending order.

The user may select a particular professional service provider, for example, based upon the suggested quote from the particular professional service provider, to proceed or to negotiate with the particular professional. If the user prefers to negotiate with the particular professional service provider, the master controller unit may negotiate with the particular professional. By way of a non-limiting example, the master controller unit may negotiate with the particular professional service provider using automatically generated emails, text messages, chat messages, and/or an automated voice call dialer and an artificial intelligence (AI) answering service. In some embodiments, a ChatGPT system may be used to facilitate negotiations between the master controller unit and the professional. The master controller unit may negotiate based upon quotes received from other professional service providers, parts that are available at a lower price than quoted by the particular professional service provider, etc.

Based upon an outcome of the negotiation with the particular professional service provider, the master controller unit may either receive confirmation or acknowledgment of the successful negotiation and may schedule the repair work automatically with the particular professional. The master controller unit may ask the user to provide one or more dates and times convenient to the user. Additionally, or alternatively, the master controller unit may request access to the user's calendar and select one or more dates and times on behalf of the user. The master controller unit may then contact the particular professional service provider with the one or more dates and times to schedule for the work to be performed for fixing the problem. However, if the outcome of the negotiation indicates failure, the master controller unit may inform the user about the same and may receive instructions from the user to negotiate with another professional service provider, as described herein, or to proceed with the same or another professional service provider without negotiation.

However, if the stakeholder selects or elects that they prefer to fix the problem as a do-it-yourself (DIY) project, the master controller unit may source one or more videos, one or more blogs, manufacturer websites, and/or any instructions that may be available online and may be useful to the user in fixing the problem as a DIY project. In some cases, the master controller unit may use a ChatGPT type AI system to help provide information to the stakeholder as part of the DIY project. The system may ask questions to the stakeholder, and based upon the answers received, may provide certain information to the stakeholder based upon the determined experience level of the stakeholder to perform this particular project. The information provided will aid the stakeholder in performing the project and will be tailored for the stakeholder and their level of experience. Similar to described above, the master controller unit may form a query (for example, a free form text query or a natural language process query) and transmit to the server using the communication interface to collect one or more videos, one or more blogs, manufacturer websites, and/or any instructions that may be available online and may be useful to the user in fixing the problem as a DIY project. The master controller unit may save the sourced one or more videos, one or more blogs, manufacturer websites, and/or instructions in a specific location (for example, a local database and/or a database in cloud) to provide easy access to the sourced content.

In some embodiments, the master controller unit may also calculate or determine a total cost of the DIY project in terms of money and/or time. Additionally, or alternatively, the master controller unit may also generate and present to the user a comparison of the total cost when the problem is fixed by a professional service provider versus when the problem is fixed as a DIY project. The master controller unit may display to the user if the user still prefers to proceed with the DIY project, and based upon receiving an input from the user confirming that the user prefers to fix the problem as the DIY project, the master controller unit may identify any parts requiring repair or replacement, and/or one or more vendors to procure the required parts based upon criteria selected by the user including, but not limited to, cost, availability, delivery date, and/or a brand or a manufacture of a part. Upon receiving user input or confirmation for the selection of the one or more vendors and the part to be ordered from each of the one or more selected vendors, the master controller unit may request the user to provide payment information or confirm with the user a particular payment method from previously saved or used payment information, to order the parts.

However, upon reviewing the comparison of the total cost when the problem is fixed by a professional service provider versus when the problem is fixed as a DIY project, if the user decides that he/she would rather have the problem fixed by the professional service provider, the master controller unit may perform operations as described herein to fix the problem using the professional. Similarly, if the user indicates that he/she prefers to perform some tasks/operations to fix the problem as a DIY project, and other using the professional service provider, the master controller unit may perform operations or actions accordingly to have the problem fixed as a mix of a DIY project and by a professional.

In some embodiments, upon the problem being fixed, for example, by the professional service provider, by the user, and/or by both the professional service provider and the user, data may be received, as described herein, from the appliance and/or the electrical/mechanical/plumbing/HVAC system. Based upon the data received after the problem is fixed, the master controller unit may confirm that the problem has now been fixed and may notify the one or more stakeholders that the problem has been addressed. The master controller unit may also provide details of the specific repair work, if available, and/or any warranty information for the one or more part and/or services. Additionally, or alternatively, using the periodically transmitted data to the master controller unit from the appliance and/or the electrical/mechanical/plumbing/HVAC system, performed repair work may be assessed frequently. The user may also be notified of any maintenance to be performed, and instruction to perform the maintenance.

The appliance, and/or the electrical/mechanical/plumbing/HVAC system, as described in the above section may be a smart appliance and/or a smart electrical/mechanical/plumbing/HVAC system and equipped with a set of at least one sensor. While the smart appliance and/or the smart electrical/mechanical/plumbing/HVAC system may communicate with the master controller using a local area network, a wide area network, a wireless personal area network, a ZigBee network, a 3G network, a 4G network, a 5G network, a 6G network, a satellite network, and/or an Internet.

However, in some examples, the appliance and/or the electrical/mechanical/plumbing/HVAC system may not be the smart appliance and/or the smart electrical/mechanical/plumbing/HVAC system. The user may then describe, using an input interface of the smart controller unit, particular symptoms, or situations that the user has observed with a specific appliance and/or an electrical/mechanical/plumbing/HVAC system. The input interface may include a keyboard, a touchscreen display configured to receive user input and/or display an output, a microphone, and/or an image sensor (e.g., a camera), a scanner (e.g., a barcode scanner, a quick response (QR) code scanner). Based upon the input received from the user, the smart controller unit may ask additional questions to identify what could be the most likely problem.

In some embodiments, the smart controller unit may include user equipment or a user device that is executing a mobile application, a native application, and/or a web-browser application that is performing various operations or tasks described herein above for the smart controller unit.

As described herein in greater detail, some embodiments include a computing device that may be referred to as an AI home unit having one or more processors that is in communication with different machines or appliances or devices (collectively appliances) (including smart appliances and smart devices) within or outside the home. In some cases, the appliance (a smart appliance) may (i) identify that there is a problem or that there is beginning to be an issue, and (ii) prompt a master AI home unit to inform the owner that maintenance on the appliance is needed. The AI home unit may (iii) determine the cause of the problem using AI tools and other data; (iv) locate the part number or elements to be inspected, repaired, and/or replaced and provides user details of the problem and how it may be resolved; (v) source parts online to fix the problem and sources costs of best quality lowest cost or other attributes the user may set; (vi) ask users with verbal prompts (chatbot) or text prompts on a user device if the home unit should order the parts required to fix the problem; and/or (vii) initiate ordering the parts and automatically applies source of payment set by the user.

Additionally, or alternatively, the AI home unit may suggest a skill level with which the repair will require from DIY to expert or a rating or grade so the user may make an assessment of whether it is possible to repair on their own. The use may select the method of the repair (1) DIY; (2) Professional service provider; or (3) a Mix. If DIY, the AI home unit may source and provide instructions, videos, prompts, or other instructions for the user to complete DIY, and a general cost structure or savings in comparison to using a professional. The user may decide at this point to use a professional service provider because of time or simply cost.

If using a professional service provider, the AI home unit may compare local professional service providers who are capable of completing the work using online ratings, feedback, reviews, and other publicly available information online. The AI home unit may provide a list of vendor choices for the user to select from, and also provide a recommendation of a preferred vendor. The user may select vendors from which to get estimates from, then the AI home unit automates contact to the vendors to provide a summary of the problem, parts defective, and receive a cost estimate of the repair. The AI home unit may then (i) provide the user with the quotes from the vendors to decide on and select a vendor to perform the repair; and/or (ii) receive input and then begins automating the scheduling of the repair using the user's digital calendar or inputs to select dates which are available.

The AI home unit may then coordinate repair dates, and the selected vendor arrives on date and provides the repair. A smart appliance may validate the repair has been completed and communicates with the AI home unit to inform the user that the issue has been resolved and provides details of the service provider for warranty claims. The smart or other appliance may provide the AI home unit with ongoing assessment of a good and valid repair, diagnostics. The AI home unit may also provide owner with maintenance instructions for the part replaced and overall maintenance guidance through prompts throughout the year.

The various embodiments in the present disclosure thus assist a user in identifying a problem with a home appliance, an electrical or a mechanical system, a plumbing system, and/or an HVAC system, alerting the user about the problem, and helping to get the problem fixed using an appropriate method. The embodiments described herein take into account various aspects including, but not limited to, cost, effectiveness, and durability, using the smart controller unit. The smart controller unit is configured to use generative artificial intelligence (AI) technology and its components/elements to determine the outputs described herein to address these issues. These embodiments are described herein using the figures discussed below.

### Exemplary Generative AI Home Maintenance Alert and Repair Automation System

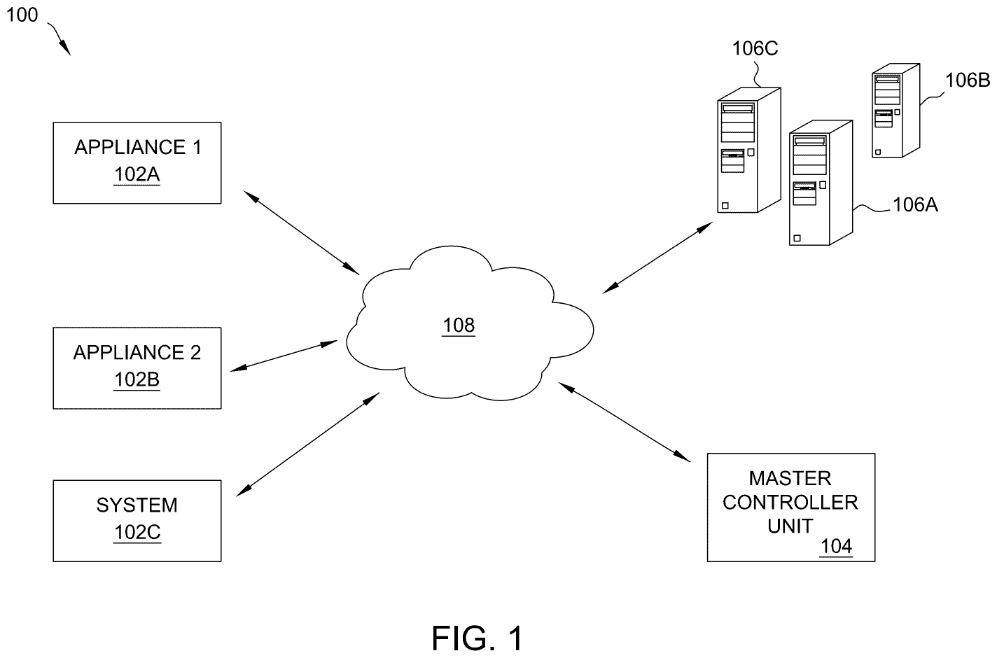

FIG. 1 depicts an exemplary generative AI home maintenance system 100 that may assist a homeowner or a stakeholder by generating and transmitting a home maintenance alert and may also help the homeowner or the stakeholder to have a problem fixed, as described according to an exemplary embodiment. As shown in FIG. 1, various appliances (e.g., smart appliances) such as appliance-1 102A and/or appliance-2 102B, and a system 102C, which may be an electrical system, a mechanical system, a plumbing system, and/or an HVAC system, as described herein, may be communicatively coupled with a master controller unit 104 via a network 108. Further, the master controller unit 104 may be communicatively coupled with one or more application servers 106A, 106B, and/or 106C via the network 108.

As described herein, the master controller unit 104 may be a smart device (such as an IOT device), and/or a user equipment (or a user device) that is configured to execute an application (e.g., a mobile application, a native application, and/or a web-browser based application), which may be referenced herein as a frontend application, to communicate with the various appliances 102A, 102B, and/or the system 102C. Accordingly, the master controller unit 104 may be a mobile device, smart watch, smart contact lenses, augmented reality glasses, virtual reality headset, mixed or extended reality headset or glasses, wearables, voice or chat bot, ChatGPT or ChatGPT-based bot, an Internet-of-Thing (IoT) device, other input device, and/or other electronic or electrical devices.

The network 108 may be a Wi-Fi network, a local area network (LAN), a wide area network (WAN), a WiMax network, a wireless personal area network, a ZigBee network, a 3G network, a 4G network, a 5G network, a 6G network, an Internet, and/or a satellite network. The one or more application servers 106A, 106B, and/or 106C may be hardware and/or a virtual machine instance, which may be collocated or geographically distributed. The one or more application servers 106A, 106B, and/or 106C may be deployed in a cloud computing network or deployed in a hosting environment of an organization providing functionalities and/or services described in the present disclosure according to one or more exemplary embodiments. An application executing on the one or more servers 106A, 106B, and/or 106C may be referenced herein as a backend application. By way of a non-limiting example, the backend application may be a monolithic application or microservices deployed in the one or more servers 106A, 106B, and/or 106C.

As described herein, and according to exemplary embodiments, the appliances 102A, 102B, and/or the system 102C, each may have at least one sensor, which may measure and collect data corresponding to one or more operating conditions, which may be used to determine whether the particular appliance or the system is working normally, or the particular appliance or the system currently has or will have some problem in the near future. Based upon the measured and collected data, in some embodiments, the appliances 102A and/or 102B, and/or the system 102C may determine that there is, or there will be, a problem, and may transmit the data to the master controller unit 104. Additionally, or alternatively, the appliance 102A and/or 102B, and/or the system 102C, transmit the measured and collected data periodically to the master controller unit 104. Based upon the received data, if the master controller unit 104 determines that there is a problem, or will have a problem, with a particular appliance and/or a system, the master controller unit 104 may generate an alert to the stakeholder. Additionally, or alternatively, the master controller unit 104 may help the stakeholder to get the problem fixed, as described herein, according to exemplary embodiments.

By way of a non-limiting example, data communicated between an appliance (such as the appliance-1 102A, the appliance-2 102B) and the master controller unit 104, and/or the system 102C and the master controller unit 104 may include raw data, audio data, video data, and/or text data, etc. Similarly, the master controller unit 104 may communicate data including one or more images, one or more video data files, text, and/or voice data, etc., with the one or more servers 106A, 106B, and/or 106C. The data may be exchanged between the master controller unit 104 and the one or more servers 106A, 106B, and/or 106C, as a webservice message over a hypertext transfer protocol (http) or a hypertext transfer protocol secure (https) protocol. The webservice message may be according to a Representational State Transfer (REST) application programming interface (API), a Simple Object Access Protocol (SOAP) API, a graph query language (GraphQL) API, a webhook API, and/or remote procedure call (RPC). The data may be communicated as (i) an extended markup language (XML), (ii) a JavaScript Object Notation (JSON), (iii) a Concise Binary Object Representation (CBOR), (iv) hypertext markup language (html), (v) a binary JSON (BSON), and/or (vi) protocol buffers.

### Exemplary Master Controller Unit or a User Equipment

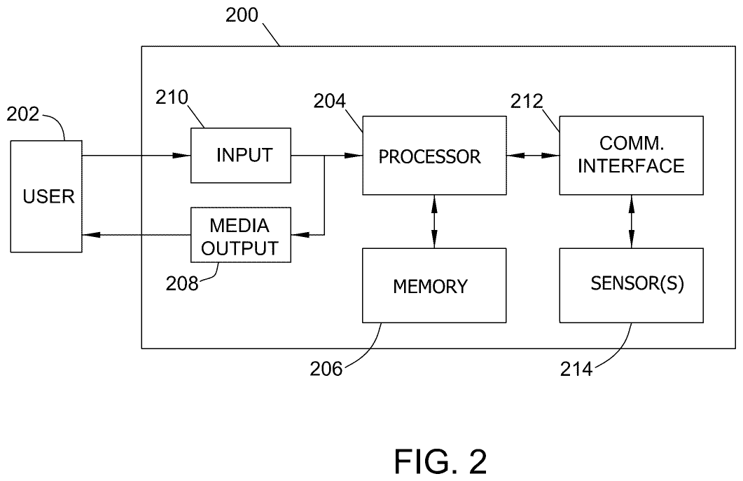

FIG. 2 depicts an exemplary configuration of a user equipment (or a user device) 200, in accordance with one embodiment of the present disclosure. The user equipment 200 may be a master controller unit 104 shown in FIG. 1. The master control unit or the user equipment 200 may include, but is not limited to, a smart phone, a tablet, a laptop, an electronic device equipped with at least one transceiver to communicate with one or more servers 106A, 106B, and/or 106C. Additionally, or alternatively, the master controller unit or the user equipment 200 may be, for example, a mobile device, smart home controller, a smart watch, smart contact lenses, augmented reality (AR) glasses, virtual reality (VR) headset, mixed or extended reality headset or glasses, wearables, voice or chat bot, an IOT device, other input device, and/or other electronic or electrical devices.

The master controller unit or the user equipment 200 may include a processor 204 for executing instructions. In some embodiments, executable instructions may be stored in a memory 206. Processor 204 may include one or more processing units (e.g., in a multi-core configuration). Memory 206 may be any device allowing information such as executable instructions and/or transaction data to be stored and retrieved. Memory 206 may include one or more computer readable media.

The master controller unit or the user equipment 200 may also include at least one media output component 208 for presenting information to user 202. Media output component 208 may be any component capable of conveying information to a user (or a stakeholder) 202. In some embodiments, media output component 208 may include an output adapter (not shown) such as a video adapter and/or an audio adapter. An output adapter may be operatively coupled to processor 204 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 208 may be configured to present a graphical user interface (e.g., a web browser and/or a client application) to the user 202. A graphical user interface may include, for example, an interface for viewing prompts and data. In some embodiments, the master controller unit or the user equipment 200 may include an input 210 for receiving input from user 202. The user 202 may use input 210 to, without limitation, provide user input.

Input device 210 may include, for example, a keyboard, a pointing device, a mouse, a stylus, a touch sensitive panel (e.g., a touch pad or a touch screen), a biometric input device, at least one vision sensor (e.g., a camera or a video camera), and/or an audio input device such as a microphone. A single component such as a touch screen display may function as both an output device of media output component 208 and input device 210.

The master controller unit or the user equipment 200 may also include a communication interface 212, communicatively coupled to a backend system, an application server, and/or one or more servers (e.g., servers 106A, 106B, and/or 106C). Communication interface 212 may include, for example, a wired or wireless network adapter and/or a wireless data transceiver for use with the network 108.

Stored in memory 206 are, for example, computer readable instructions for providing a user interface to the user 202 via media output component 208 and, optionally, receiving and processing input from input 210. A user interface may include, among other possibilities, a web browser and/or a client application. Web browsers enable users, such as user 202, to display and interact with media and other information typically embedded on a web page or a website from the backend system. A client application (e.g., a frontend application executing on the user device 200) may allow the user 202 to interact with, for example, the backend system.

In some embodiments, master controller unit or the user equipment 200 may include one or more sensors 214. By way of a non-limiting example, the one or more sensors 214 may include, but is not limited to, a gyroscope, an accelerometer, a position detector, a temperature sensor, a lux sensor (or a light level sensor), a water level sensor, an air composition sensor, an image sensor, a voice/sound sensor, a pressure sensor, a humidity sensor, an accelerometer, an infrared sensor, a vibration sensor, and/or an ultrasonic sensor.

In some embodiments, generative artificial intelligence (AI) models (also referred to as generative machine learning (ML) models) may be utilized with the present embodiments, and the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by and/or used in conjunction with reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

### Exemplary Application Server

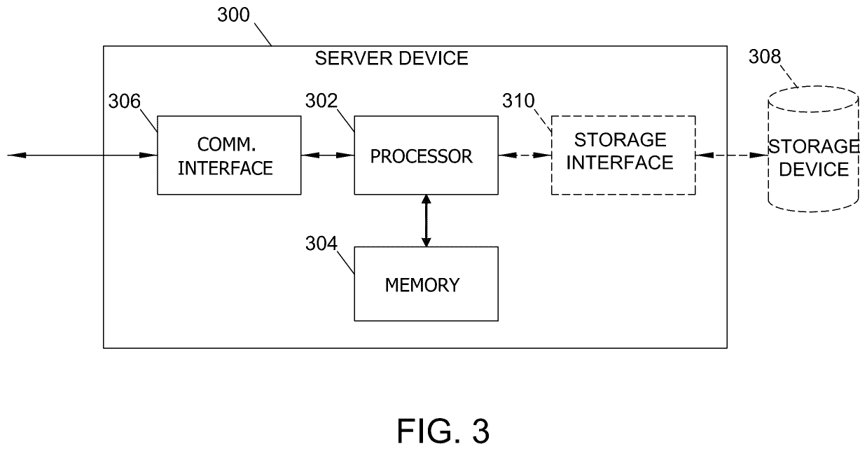

FIG. 3 depicts an exemplary configuration of an application server 300 of a backend system, in accordance with one embodiment of the present disclosure. Application server 300 may be similar to the server 106A, 106B, and/or 106C, and may be configured to perform various operations, as described herein, from the backend system perspective. Processor 302 may include one or more processing units (e.g., in a multi-core configuration). Processor 302 may be operatively coupled to a communication interface 306 such that the application server 300 is capable of communicating with a remote device, such as another application server 300, the master controller unit 104, for example, via the network 108 using wireless communication or data transmission over one or more radio links or digital communication channels. For example, communication interface 306 may receive data, e.g., image, video, and/or text. By way of a non-limiting example, the application server 300 may be a server which may receive a query from the master controller unit 104 and may transmit a query response back to the master controller unit 104.

Processor 302 may also be operatively coupled to a storage device 308. Storage device 308 may be any computer-operated hardware suitable for storing and/or retrieving data, such as, but not limited to, data associated with historic databases. In some embodiments, storage device 308 may be integrated in the application server 300. For example, the application server 300 may include one or more hard disk drives as storage device 308.

In other embodiments, storage device 308 may be external to host computing device 300 and may be accessed by a plurality of user devices 200. For example, storage device 308 may include a storage area network (SAN), a network attached storage (NAS) system, and/or multiple storage units such as hard disks and/or solid-state disks in a redundant array of inexpensive disks (RAID) configuration.

In some embodiments, processor 302 may be operatively coupled to storage device 308 via a storage interface 310. Storage interface 310 may be any component capable of providing processor 302 with access to storage device 308. Storage interface 310 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to storage device 308.

Processor 302 may execute computer-executable instructions for implementing aspects of the disclosure. In some embodiments, the processor 302 may be transformed into a special purpose microprocessor by executing computer-executable instructions or by otherwise being programmed. In some embodiments, and by way of a non-limiting example, the memory 304 may include instructions to perform specific operations, as described herein.

### Exemplary Computer-Implemented Method

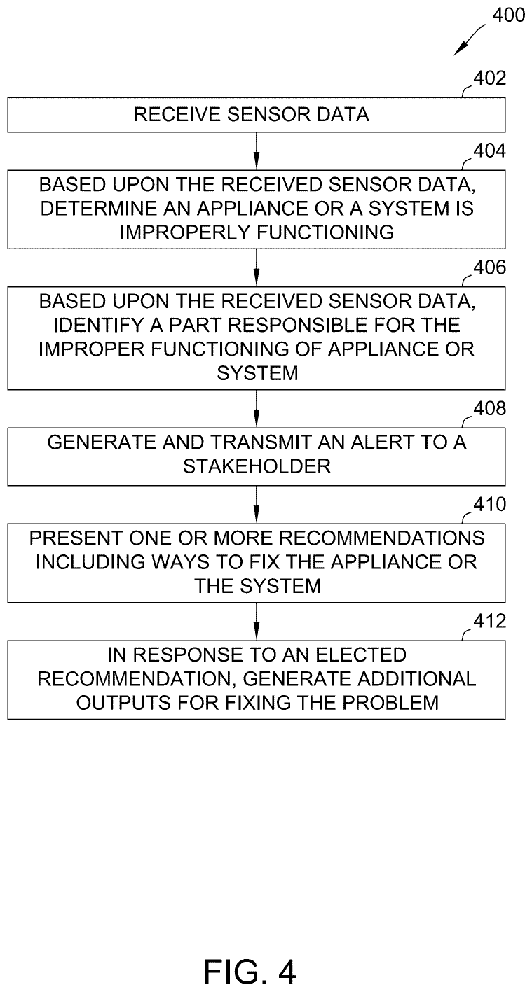

FIG. 4 depicts a flow-chart 400 of example computer-implemented method operations performed by a master controller unit 104 or a user device 200, which may be communicatively coupled with the at least one server 106A, 106B, and/or 106C, via the network 108, as described herein.

The master controller unit 104 or the user device 200 may be communicatively connected with the appliance-1 102A, the appliance-2 102B, and/or the system 102C, which may be a smart appliance and/or a smart system equipped with at least one sensor, as described herein. Using the at least one sensor, the smart appliance or the smart system may measure and collect data corresponding to one or more aspects related to functioning of the smart appliance or the smart system. The data collected by the smart appliance or the smart system using its respective at least one sensor may be received (402) by the master controller unit 104 or the user device 200, in accordance with the data being transmitted to the master controller unit 104 or the user device 200 periodically or upon meeting a specific condition. By way of a non-limiting the specific condition may be met when the data collected by the smart appliance, or the smart system is above or below a certain threshold condition.

Based upon the received data, the master controller unit 104 or the user device 200 may determine (404) that the appliance or the system is functioning improperly. As described herein, the appliance of the system is functioning improperly may be determined based upon the data that is above or below the certain threshold condition. Based upon the received data, the master controller unit 104 or the user device 200 may also identify (406) a part that may be responsible for improper functioning of the appliance or the system. For example, the data may include sensor information, an appliance type, and/or a system type, which may be used to identify or predict which part may be responsible for improper functioning of the appliance of the system.

An alert to a stakeholder may be generated and transmitted (408). The alert may identify at least one of (i) a description of the appliance or the system that is functioning improperly; (ii) the part responsible for improper functioning of the appliance or the system; and/or (iii) a skill level required to fix a problem associated with the appliance or the system, as described herein. In response to the received alert, and the stakeholder's inputs, one or more recommendations regarding ways to fix the problem may be presented (410) to the stakeholder. By way of a non-limiting example, the one or more recommendations presented to the stakeholder may include fixing the problem by a professional service provider, fixing the problem as a do-it-yourself (DIY) project, and/or a mix of the fixing the problem by the professional service provider and by the stakeholder as the DIY project.

In accordance with an election of a recommendation by the stakeholder, additional actions may be performed (412) to get the problem fixed. By way of a non-limiting example, when the recommendation elected by the stakeholder includes fixing the problem by the professional service provider, the additional actions may include generating a query for identifying a list of one or more professional service providers suitable to fix the problem, as described herein. The query may be generated based upon at least in part the appliance identified as functioning improperly, or the part responsible for improper functioning of the appliance. The generated query may be transmitted to at least one server 106A, 106B, and/or 106C via the network 108, and a query response may be received. Based upon the received query response, the list of one or more professional service providers suitable to fix the problem may be generated.

Additionally, or alternatively, a respective ranking score corresponding to each professional service provider in the list of one or more professional service providers may be generated. By way of a non-limiting example, the ranking may be generated based upon predetermined criteria including, but not limited to, a rating of each professional service provider, an experience level of each professional service provider, a charging rate of each professional service provider, and/or availability of each professional. Based upon the respective ranking score determined for each professional service provider in the list of one or more professional service providers, a subset of professional service providers from the list of one or more professional service providers may be presented or displayed to the stakeholder. Each professional service provider in the subset of professional service providers may be ordered according to the respective ranking score of each professional. For example, the professional service providers may be ordered based upon their respective ranking score in a descending order.

The stakeholder may elect or select one or more professional service providers to contact and negotiate for a quote and/or scheduling a date and a time to get the problem fixed. Similarly, when the recommendation elected by the stakeholder includes fixing the as the DIY project, the additional actions may include identifying a list of instruction materials to fix the problem. The list of instruction materials may include, but is not limited to, one or more videos, one or more blogs, and one or more manufacturer websites. The list of instruction materials may be identified based upon at least in part the appliance identified as functioning improperly, the part responsible for improper functioning of the appliance, or an identified skill level of the stakeholder or a person fixing the problem. The additional actions may also include ordering a replacement part according to criteria including at least one of: a cost, availability, a delivery date, or a brand or a manufacture of the replacement part.

The master controller unit 104 and/or the user device 200 may perform one or more operations of various operations, and/or one or more actions of the additional actions in accordance with one or more generative AI models, as described herein.

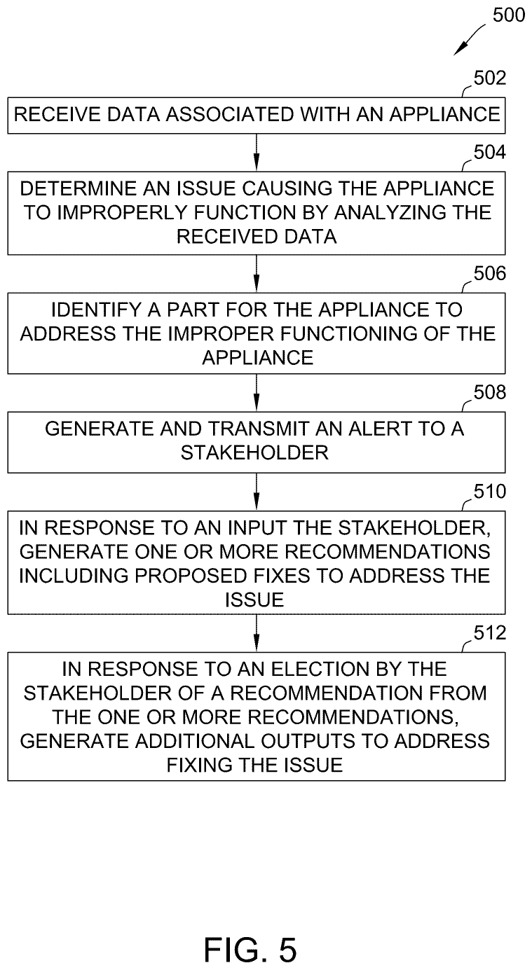

FIG. 5 depicts a flow-chart 500 of another example computer-implemented method operations performed by a master controller unit 104 or a user device 200, which may be communicatively coupled with the at least one server 106A, 106B, and/or 106C, via the network 108, as described herein.

The master controller unit 104 or the user device 200 may receive (502) data associated with an appliance. The received data may include data corresponding to a measurement of one or more aspects related to a functioning of an appliance (e.g., the appliance-1 102A or the appliance-2 102B) or system (e.g., the system 102C) and/or inputs corresponding to an issue related to the appliance or system. The appliance or system may not be the smart appliance or smart system and may not be communicatively coupled with the master controller unit 104 or the user device to transmit data related to functioning of the appliance or the system. Accordingly, a user may provide inputs to the master controller unit 104 or the user device when an issue may be suspected by the user. The inputs may include at least one of (i) audio data; (ii) video data; and/or (iii) text data. Additionally, or alternatively, the appliance or system may be a smart appliance or smart system that is communicatively coupled with the master controller unit 104 or the user device to transmit data related to functioning of the appliance of system. The data may be transmitted automatically and periodically. Alternatively, the data may be transmitted upon occurrence of a particular event.

Based upon the received data or by analyzing the received data, the master controller unit 104 or the user device 200 may determine (504) an issue causing the appliance or system to improperly function. As described herein, the appliance of the system is improperly functioning may be determined based upon the data including, for example, the measurement of one or more aspects related to the functioning of the appliance or system, and/or a description of the issue provided by the user. Based upon the received inputs, the master controller unit 104 or the user device 200 may also identify (506) a part for the appliance or system to address for the improper functioning of the appliance or system.

An alert may be generated and transmitted (508) to a stakeholder. By way of a non-limiting example, the alert may identify at least one of: a description of the appliance that is improperly functioning, the part identified to address the improper functioning of the appliance, and a skill level required to fix the issue associated with the appliance. The stakeholder may provide an input based at least in part upon the received alert, and in response to the input from the stakeholder, one or more recommendations including proposed fixes to address the issue may generated (510). By way of a non-limiting example, the one or more recommendations may include fixing the problem by a professional service provider, fixing the problem as a do-it-yourself (DIY) project, and/or a mix of the fixing the problem by the professional service provider and by the stakeholder as the DIY project.

In accordance with an election of a recommendation by the stakeholder, additional actions may be performed or additional outputs to address fixing the issued may be generated (512). By way of a non-limiting example, when the recommendation elected by the stakeholder includes fixing the problem by the professional service provider, the additional actions may include generating a query for identifying a list of one or more professional service providers suitable to fix the problem, as described herein. The query may be generated based upon at least in part the appliance identified as functioning improperly, or the part responsible for improper functioning of the appliance. The generated query may be transmitted to at least one server 106A, 106B, and/or 106C via the network 108, and a query response may be received. Based upon the received query response, the list of one or more professional service providers suitable to fix the problem may be generated.

Additionally, or alternatively, a respective ranking score corresponding to each professional service provider in the list of one or more professional service providers may be generated. By way of a non-limiting example, the ranking may be generated based upon predetermined criteria including, but not limited to, a rating of each professional service provider, an experience level of each professional service provider, a charging rate of each professional service provider, and/or availability of each professional. Based upon the respective ranking score determined for each professional service provider in the list of one or more professional service providers, a subset of professional service providers from the list of one or more professional service providers may be presented or displayed to the stakeholder. Each professional service provider in the subset of professional service providers may be ordered according to the respective ranking score of each professional. For example, the professional service providers may be ordered based upon their respective ranking score in a descending order.

The stakeholder may elect or select one or more professional service providers to contact and negotiate for a quote and/or scheduling a date and a time to get the problem fixed. Similarly, when the recommendation elected by the stakeholder includes fixing the as the DIY project, the additional actions may include identifying a list of instruction materials to fix the problem. The list of instruction materials may include, but is not limited to, one or more videos, one or more blogs, and one or more manufacturer websites. The list of instruction materials may be identified based upon at least in part the appliance identified as functioning improperly, the part responsible for improper functioning of the appliance, or an identified skill level of the stakeholder or a person fixing the problem. The additional actions may also include ordering a replacement part according to criteria including at least one of: a cost, availability, a delivery date, or a brand or a manufacture of the replacement part.

The master controller unit 104 and/or the user device 200 may perform one or more operations of various operations, and/or one or more actions of the additional actions in accordance with one or more generative AI models, as described herein.

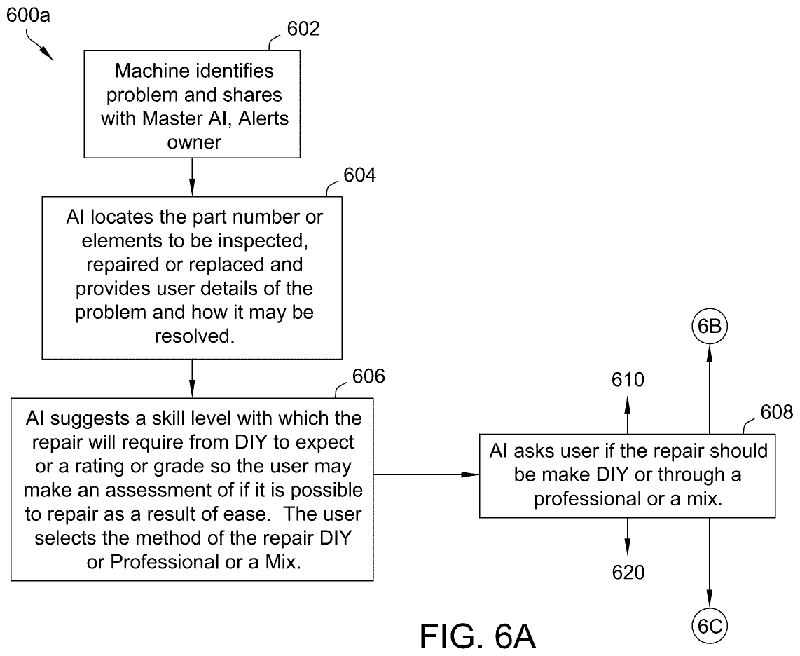

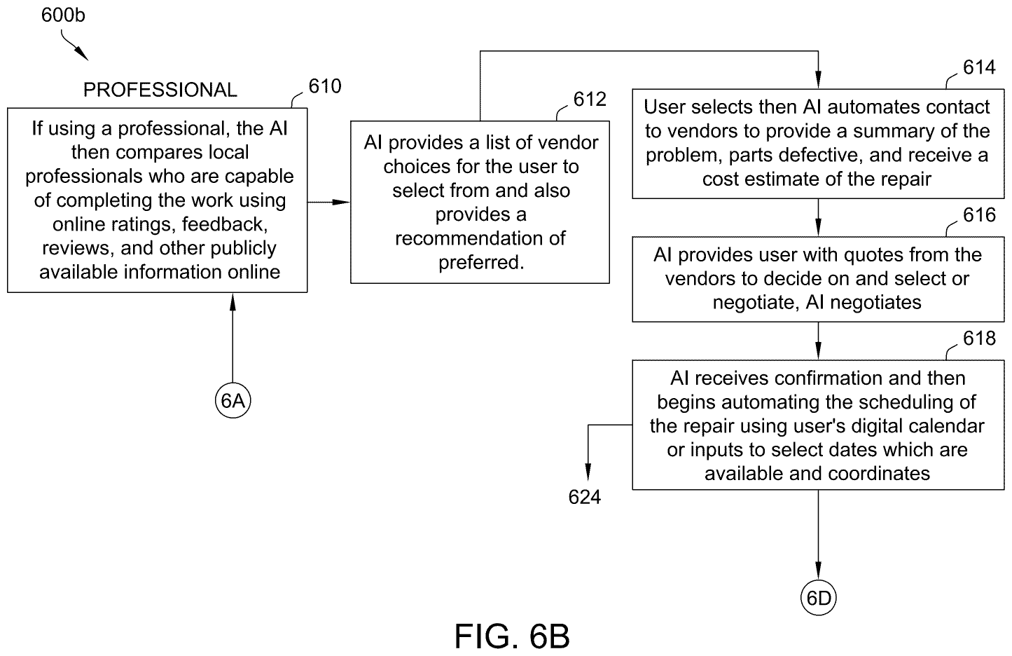

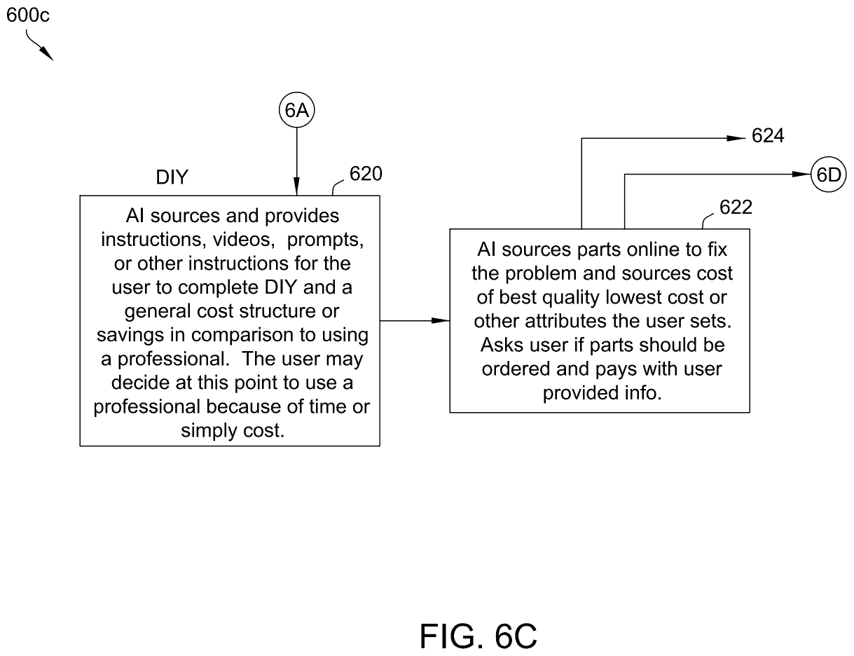

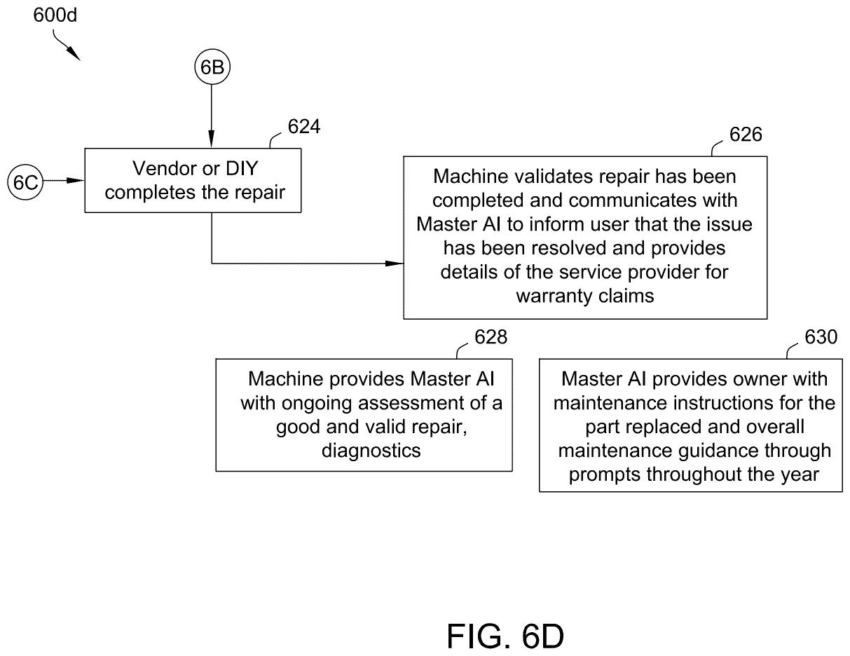

FIGS. 6A-6D depict a flow-chart of example operations for assisting the homeowner or the stakeholder in having a problem fixed, in accordance with certain embodiments of the present disclosure. As shown in a flow-chart 600a of FIG. 6A, a machine, a system, or an appliance may identify (602) a problem or an issue and report the identified problem or issue to the master controller unit 104. The master controller unit 104 may also be referenced herein as a master AI or an AI home unit or an AI computing device. The machine, system, or appliance may collect diagnostic or operational data from one or more sensors and report the diagnostic or operational data to the master AI unit. The master AI unit may analyze the diagnostic or operational data received from the machine, system, or appliance, and may report to the homeowner or the stakeholder an issue or problem in the machine, system, or appliance based upon the analyzed diagnostic or operational data. In some examples, the issue or problem may not yet be present, but the analysis of the diagnostic or operational data may suggest the issue or problem may occur. The master AI unit may alert the homeowner or the stakeholder of the issue or problem (or beginning of the issue or problem), as described in the present disclosure.

The master AI unit may locate or identify (604) part number or elements to be inspected, repaired, or replaced for providing details to the homeowner or stakeholder about the problem or issue and possible ways the problem or issue may be solved. By way of a non-limiting example, the master AI unit may identify the part number or elements to be inspected, repaired, or replaced based upon details of the machine, system, or appliance, and the diagnostic or operational data. The master AI unit may identify whether the problem or issue is simple enough to be fixed by the homeowner or stakeholder or require a professional service provider to fix the problem or issue. Based upon the skills required to fix the problem, and complexity of the problem, the master AI unit may suggest (606) to the homeowner or stakeholder, the required skill level (or a rating or grade) to fix the problem so that the homeowner or stakeholder may make an assessment of whether the homeowner would prefer the problem to be fixed by a professional service provider, as a DIY project, or a mix of the professional service provider and the DIY project. The master AI unit may ask (608), either through a verbal or audio chatbot prompt or through a text being displayed on a user device, the homeowner or stakeholder, how the problem should be fixed.

In case the homeowner or stakeholder selects that the problem should be fixed by a professional service provider, as shown in a flow-chart 600b of FIG. 6B, the master AI unit may compare (610) professional service providers based on their availability and capability to complete the repair work based upon online ratings, feedback, reviews, and/or other publicly available online information about the professional service providers. The Al home unit may then provide (612) a list of vendor choices for the homeowner or stakeholder to select from and provide a recommendation of a preferred vendor. The homeowner or stakeholder may select one or more vendors, and the AI home unit may then automatically contact (614) the selected one or more vendors to provide a summary of the issue or problem, and/or defective parts for receiving a cost estimate for the repair. The AI home unit may provide (616) the homeowner or stakeholder with the received quotes from the one or more vendors to decide and select a vendor for performing the repair work. Based upon the selection of the vendor by the owner, the Al home unit may automatically begin scheduling (618) of the repair work using the owner's digital calendar or based upon the owner's input regarding available dates and may coordinate with the selected vendor for the repair work. After the repair work is completed by the professional service provider, an operation marked as 624 in a flow-chart 600d of FIG. 6D may be performed.

If the method selected for repairing is a DIY project, then the master AI unit may source (or collect) (620) and provide instructions, videos, prompts, and/or other information for the owner (or user) to complete the DIY project as shown in a flow-chart 600c of FIG. 6C. The master AI unit may provide a general cost structure or savings in comparison to using a professional service provider to complete the repair in order for the user to decide whether to complete the repair using the professional service provider or as the DIY project based on time or cost considerations. The master AI unit may source (622) required parts online to fix the issue or problem and may source parts of best quality, lowest cost, and/or other attributes as set by the owner (or user). The master AI unit may ask the homeowner or stakeholder whether the parts required to fix the issue or problem should be ordered, and based upon the owner's response, the master AI unit may order the parts and may automatically apply payment to a source of payment setup by the homeowner or stakeholder. After the repair work is completed by the homeowner or stakeholder as the DIY project, an operation marked as 624 in the flow-chart 600d of FIG. 6D may be performed.

Upon completion (624) of the repair work by the selected vendor (or as the DIY project or mix), the machine, system, or appliance may validate (626) the repair work and communicate to the master AI unit to report that the issue or problem is resolved. Additionally, or alternatively, details of the repair work and/or the service provider may be provided to the master AI unit for warranty claims. The machine, system, or appliance may also provide (628) diagnostic data and/or ongoing assessment data to the master AI unit, and the master AI unit may provide (630) the homeowner or stakeholder with maintenance instructions for the replaced part and/or overall maintenance guidance through prompts regularly.

The master AI unit may perform one or more operations described herein in accordance with one or more generative AI models.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, home maintenance system 100 is configured to implement machine learning, such that computer system 100 “learns” to analyze, organize, and/or process data without being explicitly programmed. Machine learning may be implemented through machine learning methods and algorithms (“ML methods and algorithms”). In one exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features or with a large sample of other data with known characteristics or features. Such information may include, for example, information associated with a plurality of images and/or other data of a plurality of different objects, items, and/or property including appliances and/or other systems.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### Additional Exemplary Embodiments

Additional exemplary embodiments of the systems and methods described herein are provided herein. For example, in one embodiment, an electronic device may include at least one memory and at least one processor in communication with the at least one memory. The at least one processor may be programmed to: (i) receive data associated with an appliance, the data corresponding to a measurement of one or more aspects related to a functioning of the appliance; (ii) determine an issue causing the appliance to improperly function by analyzing the received data associated with the appliance; (iii) identify a part for the appliance to address the improper functioning of the appliance; (iv) generate and transmit an alert to a stakeholder, the alert identifying at least one of: a description of the appliance that is improperly functioning, the part identified to address the improper functioning of the appliance, and a skill level required to fix the issue associated with the appliance; (v) in response to an input from the stakeholder, generate one or more recommendations including proposed fixes to address the issue; and/or (vi) in response to an election by the stakeholder of a recommendation from the one or more recommendations, generate additional outputs to address fixing the issue.

Further, the electronic device in accordance with the preceding aspects may further include wherein the one or more recommendations include fixing the issue by a professional service provider, fixing the issue as a do-it-yourself (DIY) project, or a mix of fixing the issue by the professional service provider and as a DIY project.

Further, the electronic device in accordance with any of the preceding aspects may further include wherein the recommendation elected by the stakeholder may include fixing the problem by the professional service provider, and the at least one processor may be further programmed to generate a query for identifying a list of one or more professional service providers suitable to fix the problem, the query may be generated based at least in part on the appliance identified as improperly functioning, or the part responsible for the improper functioning of the appliance, and based upon a query response to the generated query, generate the list of one or more professional service providers suitable to fix the problem.

Additionally, or alternatively, the electronic device in accordance with any of the preceding aspects may further include the at least one processor being further programmed to: (i) generate a respective ranking score corresponding to each professional service provider on the list of one or more professional service providers based upon predetermined criteria, the predetermined criteria including at least one of a rating of each professional service provider, an experience level of each professional service provider, a charging rate of each professional service provider, or an availability of each professional service provider; (ii) based upon the respective ranking score determined for each professional service provider on the list of one or more professional service providers, present a subset of professional service providers from the list of one or more professional service providers to the stakeholder ordered according to the respective ranking score of each professional service provider from the subset of professional service providers; and/or (iii) receive information corresponding to one or more professional service providers selected by the stakeholder from the subset of professional service providers.

In addition, the electronic device in accordance with any of the preceding aspects may further include the at least one processor being further programmed to contact and negotiate with a professional service provider for at least one of a quote or scheduling a date and a time to fix the problem.

In addition, the electronic device in accordance with any of the preceding aspects may further include wherein the recommendation elected by the stakeholder includes fixing the problem as a DIY project, and the at least one processor may be further programmed to identify a list of instruction materials to fix the problem based upon at least in part the appliance identified as improperly functioning, the part associated with the improper functioning of the appliance, or an identified skill level of the stakeholder.

In addition, the electronic device in accordance with any of the preceding aspects may further include wherein the recommendation elected by the stakeholder includes fixing the problem by the stakeholder as the DIY project, and to identify a list of instruction materials to fix the issue, the at least one processor may be further programmed to generate a comparison of a cost of resources required to fix the issue by the professional service provider with a cost of resources required to fix the issue as the DIY project, and present the generated comparison to the stakeholder.

In addition, the electronic device in accordance with any of the preceding aspects may further include wherein the recommendation elected by the stakeholder includes fixing the problem by the stakeholder as the DIY project, and to identify a list of instruction materials to fix the problem, the at least one processor may be further programmed to order a replacement part according to criteria including at least one of: a cost, availability, a delivery date, or a brand or a manufacture of the replacement part.

In addition, the electronic device in accordance with any of the preceding aspects may further include the at least one processor being further programmed to: (i) collect additional data relating to the improperly functioning appliance after the appliance has been fixed; (ii) validate that the problem has been fixed; and/or (iii) provide details corresponding to the fix, the details including at least one of: description of one or more actions taken to fix the problem, or warranty information associated with the fix.

In addition, the electronic device in accordance with any of the preceding aspects may further include wherein the one or more recommendations, or the additional outputs, are generated in accordance with one or more generative artificial intelligence (AI) models.

In another embodiment, a computer-implemented method is disclosed. The computer-implemented method, which may be implemented using one or more processors, may include: (i) receiving data from the appliance or system, the data corresponding to a measurement of one or more aspects related to the functioning of the appliance or system; (ii) based upon the received data, determining that the appliance or system is improperly functioning; (iii) based upon the received data, identifying a part associated with the improper functioning of the appliance or system; (iv) generating and transmitting an alert to a stakeholder, the alert identifying at least one of: a description of the appliance or system that is improperly functioning, the part associated with the improper functioning of the appliance or system, and a skill level required to fix the improperly functioning appliance or system; (v) in response to an input from the stakeholder, generating one or more recommendations including proposed fixes to the appliance or system; and/or (vi) in response to an election by the stakeholder of a recommendation from the one or more recommendations, performing additional steps to facilitate fixing the improperly functioning appliance or system.

Further, the computer-implemented method in accordance with the preceding operations may further include wherein the one or more recommendations may include fixing the improperly functioning appliance or system by a professional service provider, fixing the improperly functioning appliance or system as a do-it-yourself (DIY) project, or a mix of fixing the improperly functioning appliance or system by the professional service provider and by the stakeholder as a DIY project.

Additionally, or alternatively, the computer-implemented method in accordance with any of the preceding operations may further include wherein the recommendation elected by the stakeholder may include fixing the problem by the professional service provider, and the performing the additional steps may include (i) generating a query for identifying a list of one or more professional service providers suitable to fix the improperly functioning appliance or system, the query is generated based upon at least in part the appliance or system identified as improperly functioning, or the part associated with the improperly functioning appliance or system; and (ii) based upon a query response to the generated query, generating the list of one or more professional service providers suitable to fix the improperly functioning appliance or system.

In addition, the computer-implemented method in accordance with any of the preceding operations may further include performing the additional steps may include (i) generating a respective ranking score corresponding to each professional service provider in the list of one or more professional service providers based upon predetermined criteria, the predetermined criteria including at least one of a rating of each professional service provider, an experience level of each professional service provider, a charging rate of each professional service provider, or availability of each professional service provider; (ii) based upon the respective ranking score determined for each professional service provider in the list of one or more professional service providers, presenting a subset of professional service providers from the list of one or more professional service providers to the stakeholder ordered by the respective ranking score of each professional service provider from the subset of professional service providers; and/or (iii) receiving information corresponding to one or more professional service providers selected by the stakeholder from the subset of professional service providers.

In addition, the computer-implemented method in accordance with any of the preceding operations may further include performing the additional steps may include contacting and negotiating with a professional service provider for at least one of a quote or scheduling a date and a time to fix the improperly functioning appliance or system.

In addition, the computer-implemented method in accordance with any of the preceding operations may further include wherein the recommendation elected by the stakeholder may include fixing the problem as the DIY project, and the performing the additional steps may include based upon at least (i) the appliance being identified as improperly functioning, (ii) the part associated with the improperly functioning appliance or system, or (iii) an identified skill level of the stakeholder, identifying a list of instructional materials to facilitate fixing the improperly functioning appliance or system.

In addition, the computer-implemented method in accordance with any of the preceding operations may further include performing the additional steps may include generating a comparison of a cost of resources required to fix the improperly functioning appliance or system by the professional service provider with a cost of resources required to fix the improperly functioning appliance or system as a DIY project, and presenting the generated comparison to the stakeholder.

In addition, the computer-implemented method in accordance with any of the preceding operations may further include performing the additional steps may include ordering a replacement part to address the improperly functioning appliance or system based upon criteria that includes at least one of: a cost, availability, a delivery date, or a brand or a manufacture of the replacement part.

In addition, the computer-implemented method in accordance with any of the preceding operations may further include based upon the received data, identifying that the appliance or system requires maintenance, and generating and transmitting a notification to the stakeholder, the notification including at least one of: a description of the appliance or system requiring maintenance, or instructions regarding how to perform the required maintenance.

In yet another embodiment, a computer-implemented method, which may be implemented using one or more processors, is disclosed. The computer-implemented method may include: (i) receiving inputs corresponding to an issue related to an appliance or a system, the inputs including at least one of: audio data, video data, or text data; (ii) based upon the received inputs, determining that the appliance or the system is functioning improperly; (iii) based upon the received inputs, identifying a part responsible for improper functioning of the appliance or the system; (iv) presenting one or more recommendations to a user on ways to fix the issue; and/or (v) in response to an election by the user of a recommendation from the one or more recommendations, performing additional actions to get the issue fixed.

In one aspect, a non-transitory computer-readable storage media having computer-executable instructions embodied thereon for processing data and providing relocation alerts may be provided. When executed by at least one processor of a data processing computing device, the computer-executable instructions may cause the at least one process in communication with the at least one database to: (i) receive inputs corresponding to an issue related to an appliance or system, the inputs including at least one of: audio data, video data, or text data; (ii) determine that the appliance or system is improperly functioning based on the received inputs; (iii) identify an issue with the improperly functioning appliance or system including a part associated with the improperly functioning appliance or system that requires replacing or repairing; (iv) present one or more recommendations to a user including options to fix the issue with the improperly functioning appliance or system; and/or (vi) in response to an election by the user of a recommendation from the one or more recommendations, provide additional information to facilitate fixing the issue with the improperly functioning appliance or system.

Further, the non-transitory computer-readable storage media with instructions embodied thereon in accordance with the preceding aspects may further include wherein the one or more recommendations may include fixing the issue by a professional service provider, fixing the problem as a do-it-yourself (DIY) project, or a mix of the fixing the problem by the professional service provider and as the DIY project.

Further, the non-transitory computer-readable storage media with instructions embodied thereon in accordance with the preceding aspects may further include wherein the recommendation elected by the stakeholder may include fixing the issue by the professional service provider, and the instructions cause the at least one processor to generate a query for identifying a list of one or more professional service providers suitable to fix the issue, the query may be generated based at least in part on the appliance identified as improperly functioning, or the part responsible for the improper functioning of the appliance, and based upon a query response to the generated query, generate the list of one or more professional service providers suitable to fix the problem.

Additionally, or alternatively, the non-transitory computer-readable storage media with instructions embodied thereon in accordance with the preceding aspects may further include instructions that cause the at least one processor to: (i) generate a respective ranking score corresponding to each professional service provider in the list of one or more professional service providers based upon predetermined criteria, the predetermined criteria including at least one of a rating of each professional service provider, an experience level of each professional service provider, a charging rate of each professional service provider, or an availability of each professional service provider; (ii) based upon the respective ranking score determined for each professional service provider in the list of one or more professional service providers, present a subset of professional service providers from the list of one or more professional service providers to the stakeholder ordered according to the respective ranking score of each professional service provider from the subset of professional service providers; and/or (iii) receive information corresponding to one or more professional service providers selected by the stakeholder from the subset of professional service providers.

In addition, the non-transitory computer-readable storage media with instructions embodied thereon in accordance with the preceding aspects may further include instructions that cause the at least one processor to contact and negotiate with a professional service provider for at least one of a quote or scheduling a date and a time to fix the problem.

In addition, the non-transitory computer-readable storage media with instructions embodied thereon in accordance with the preceding aspects may further include wherein the recommendation elected by the stakeholder includes fixing the problem as a DIY project, and the at least one processor may be further instructed to identify a list of instruction materials to fix the problem based upon at least in part the appliance identified as functioning improperly, the part responsible for improper functioning of the appliance, or an identified skill level of the stakeholder.

In addition, the non-transitory computer-readable storage media with instructions embodied thereon in accordance with the preceding aspects may further include wherein the recommendation elected by the stakeholder includes fixing the issue by the stakeholder as the DIY project, and to identify a list of instruction materials to fix the problem, the at least one processor may be further instructed to generate a comparison of a cost of resources required to fix the issue by the professional service provider with a cost of resources required to fix the problem as the DIY project, and present the generated comparison to the stakeholder.

In addition, the non-transitory computer-readable storage media with instructions embodied thereon in accordance with the preceding aspects may further include wherein the recommendation elected by the stakeholder includes fixing the issue by the stakeholder as the DIY project, and to identify a list of instruction materials to fix the problem, the at least one processor may be further programmed to order a replacement part according to criteria including at least one of: a cost, availability, a delivery date, or a brand or a manufacture of the replacement part.

In addition, the non-transitory computer-readable storage media with instructions embodied thereon in accordance with the preceding aspects may further include instructions that cause the at least one processor to: (i) collect additional data relating to the improperly functioning appliance after the appliance has been fixed; (ii) validate that the problem has been fixed; and/or (iii) provide details corresponding to the fix, the details including at least one of: description of one or more actions taken to fix the issue, or warranty information associated with the fix.

In addition, the non-transitory computer-readable storage media with instructions embodied thereon in accordance with the preceding aspects may further include wherein the one or more recommendations, or the additional outputs, are generated in accordance with one or more generative artificial intelligence (AI) models.

Additionally, or alternatively, in some examples, a machine, a system, or an appliance may identify that there is a problem or that there is a beginning of an issue and may prompt a master AI home unit to inform the owner that maintenance is needed. The AI home unit may source or identify a cause of the issue or problem. The AI home unit may then locate the part number or elements to be inspected, repaired, and/or replaced, and may provide details of the issue or problem and how to resolve the issue or problem. The AI home unit may source required parts online to fix the issue or problem and may source parts of best quality, lowest cost, and/or other attributes as set by the owner (or user).

In some examples, the AI home unit may ask the owner (or user) whether the parts required to fix the issue or problem should be ordered, and based upon the owner's response, the AI home unit may order the parts and may automatically apply payment to a source of payment setup by the owner.

In some examples, the AI home unit may ask the owner whether the repair should be made by a professional service provider or by the owner as a DIY project. The AI home unit may suggest a skill level required for the repair when the repair is performed as a DIY project or by a professional. Additionally, or alternatively, a rating or grade required for performing the repair may also be suggested such that the owner may make an assessment of whether the repair should be performed by a professional service provider or as a DIY project. The owner may select a method for repairing such as a DIY project, by a professional service provider, or a mix.

If the method selected for repairing is a DIY project, then the AI home unit may source (or collect) and provide instructions, videos, prompts, and/or other information for the owner (or user) to complete the DIY project. The AI home unit may provide a general cost structure or savings in comparison to using a professional service provider to complete the repair in order for the user to decide whether to complete the repair using the professional service provider or as the DIY project based on time or cost considerations.

If the method selected for repairing is through a professional service provider, the AI home unit may compare professional service providers based on their availability and capability to complete the repair work based upon online ratings, feedback, reviews, and/or other publicly available online information about the professional service providers. The AI home unit may then provide a list of vendor choices for the owner (or user) to select from and provide a recommendation of a preferred vendor. The owner (or user) may select one or more vendors, and the AI home unit may then automatically contact the selected one or more vendors to provide a summary of the issue or problem, and/or defective parts for receiving a cost estimate for the repair. The AI home unit may provide the owner the received quotes from the one or more vendors to decide and select a vendor for performing the repair work. Based upon the selection of the vendor by the owner, the AI home unit may automatically begin scheduling of the repair work using the owner's digital calendar or based upon the owner's input regarding available dates and may coordinate with the selected vendor for the repair work.

Upon completion of the repair work by the selected vendor (or as the DIY project or mix), the machine, system, or appliance may validate the repair work and communicate to the AI home unit to report that the issue or problem is resolved. Additionally, or alternatively, details of the repair work and/or the service provider may be provided to the AI home unit for warranty claims. The machine, system, or appliance may also provide diagnostic data and/or ongoing assessment data to the AI home unit, and the AI home unit may provide the owner (or user) maintenance instructions for the replaced part and/or overall maintenance guidance through prompts regularly.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system may be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electronic device comprising:
at least one memory; and
at least one processor in communication with the at least one memory, wherein the at least one processor is programmed to:
receive data associated with an appliance, the data corresponding to a measurement of one or more aspects related to a functioning of the appliance;
determine an issue causing the appliance to improperly function by analyzing the received data associated with the appliance;
identify a part for the appliance to address the improper functioning of the appliance;
generate and transmit an alert to a stakeholder, the alert identifying at least one of: a description of the appliance that is improperly functioning, the part identified to address the improper functioning of the appliance, and a skill level required to fix the issue associated with the appliance;
in response to an input from the stakeholder, generate one or more recommendations including proposed fixes to address the issue; and
in response to an election by the stakeholder of a recommendation from the one or more recommendations, generate additional outputs to address fixing the issue.

2. The electronic device of claim 1, wherein the one or more recommendations include fixing the issue by a professional service provider, fixing the issue as a do-it-yourself (DIY) project, or a mix of fixing the issue by the professional service provider and as a DIY project.

3. The electronic device of claim 2, wherein:
the recommendation elected by the stakeholder includes fixing the issue by the professional service provider; and
the at least one processor is further programmed to:
generate a query for identifying a list of one or more professional service providers suitable to fix the issue, the query is generated based at least in part on the appliance identified as improperly functioning, or the part responsible for the improper functioning of the appliance; and
based upon a query response to the generated query, generate the list of one or more professional service providers suitable to fix the issue.

4. The electronic device of claim 3, wherein the at least one processor is further programmed to:
generate a respective ranking score corresponding to each professional service provider on the list of one or more professional service providers based upon predetermined criteria, the predetermined criteria including at least one of a rating of each professional service provider, an experience level of each professional service provider, a charging rate of each professional service provider, or an availability of each professional service provider;
based upon the respective ranking score determined for each professional service provider on the list of one or more professional service providers, present a subset of professional service providers from the list of one or more professional service providers to the stakeholder ordered according to the respective ranking score of each professional service provider from the subset of professional service providers; and
receive information corresponding to one or more professional service providers selected by the stakeholder from the subset of professional service providers.

5. The electronic device of claim 3, wherein the at least one processor is further programmed to contact and negotiate with a professional service provider for at least one of a quote or scheduling a date and a time to fix the issue.

6. The electronic device of claim 2, wherein:
the recommendation elected by the stakeholder includes fixing the issue as a DIY project; and
the at least one processor is further programmed to:
identify a list of instructional materials to fix the issue based upon at least in part the appliance identified as improperly functioning, the part associated with the improper functioning of the appliance, or an identified skill level of the stakeholder.

7. The electronic device of claim 2, wherein:
the recommendation elected by the stakeholder includes fixing the issue by the stakeholder as a DIY project; and
the at least one processor is further programmed to:
identify a list of instructional materials to fix the issue including: generate a comparison of a cost of resources required to fix the issue by the professional service provider with a cost of resources required to fix the issue as a DIY project; and present the generated comparison to the stakeholder.

8. The electronic device of claim 2, wherein:
the recommendation elected by the stakeholder includes fixing the issue by the stakeholder as a DIY project; and
the at least one processor is further programmed to:
identify a list of instructional materials to fix the issue including ordering a replacement part according to criteria including at least one of: a cost, availability, a delivery date, or a brand or a manufacture of the replacement part.

9. The electronic device of claim 2, wherein at least one processor is further programmed to:
collect additional data relating to the improperly functioning appliance after the appliance has been fixed;
validate that the issue has been fixed; and
provide details corresponding to the fix, the details including at least one of:
a description of one or more actions taken to fix the issue, or warranty information associated with the fix.

10. The electronic device of claim 1, wherein the one or more recommendations, or the additional outputs, are generated using one or more generative artificial intelligence (AI) models.

11. A computer-implemented method for identifying an issue with an appliance or system, the computer-implemented method implemented using a computing device including at least one processor and at least one memory, the computer implemented-method comprising:
receiving data from the appliance or system, the data corresponding to a measurement of one or more aspects related to the functioning of the appliance or system;
based upon the received data, determining that the appliance or system is improperly functioning;
based upon the received data, identifying a part associated with the improper functioning of the appliance or system;
generating and transmitting an alert to a stakeholder, the alert identifying at least one of: a description of the appliance or system that is improperly functioning, the part associated with the improper functioning of the appliance or system, and a skill level required to fix the improperly functioning appliance or system;
in response to an input from the stakeholder, generating one or more recommendations including proposed fixes to the appliance or system; and
in response to an election by the stakeholder of a recommendation from the one or more recommendations, performing additional steps to facilitate fixing the improperly functioning appliance or system.

12. The computer-implemented method of claim 11, wherein the one or more recommendations include fixing the improperly functioning appliance or system by a professional service provider, fixing the improperly functioning appliance or system as a do-it-yourself (DIY) project, or a mix of fixing the improperly functioning appliance or system by the professional service provider and by the stakeholder as a DIY project.

13. The computer-implemented method of claim 12, wherein the recommendation elected by the stakeholder includes fixing the improperly functioning appliance or system by the professional service provider, and wherein the performing of the additional steps further comprises:
generating a query for identifying a list of one or more professional service providers suitable to fix the improperly functioning appliance or system, the query is generated based upon at least in part the appliance or system identified as improperly functioning, or the part associated with the improperly functioning appliance or system; and
based upon a query response to the generated query, generating the list of one or more professional service providers suitable to fix the improperly functioning appliance or system.

14. The computer-implemented method of claim 13, wherein the performing additional steps further comprises:
generating a respective ranking score corresponding to each professional service provider in the list of one or more professional service providers based upon predetermined criteria, the predetermined criteria including at least one of a rating of each professional service provider, an experience level of each professional service provider, a charging rate of each professional service provider, or availability of each professional service provider;
based upon the respective ranking score determined for each professional service provider in the list of one or more professional service providers, presenting a subset of professional service providers from the list of one or more professional service providers to the stakeholder ordered by the respective ranking score of each professional service provider from the subset of professional service providers; and
receiving information corresponding to one or more professional service providers selected by the stakeholder from the subset of professional service providers.

15. The computer-implemented method of claim 13, wherein the performing additional steps further comprises contacting and negotiating with a professional service provider for at least one of a quote or scheduling a date and a time to fix the improperly functioning appliance or system.

16. The computer-implemented method of claim 12, wherein the recommendation elected by the stakeholder includes fixing the improperly functioning appliance or system as a DIY project, and wherein the performing the additional steps further comprises:
based upon at least (i) the appliance being identified as improperly functioning, (ii) the part associated with the improperly functioning appliance or system, or (iii) an identified skill level of the stakeholder, identifying a list of instructional materials to facilitate fixing the improperly functioning appliance or system.

17. The computer-implemented method of claim 16, wherein the performing additional steps further comprises:
generating a comparison of a cost of resources required to fix the improperly functioning appliance or system by the professional service provider with a cost of resources required to fix the improperly functioning appliance or system as a DIY project; and
presenting to the stakeholder the generated comparison.

18. The computer-implemented method of claim 16, wherein the performing additional steps further comprises ordering a replacement part to address the improperly functioning appliance or system based upon criteria that includes at least one of: a cost, availability, a delivery date, or a brand or a manufacture of the replacement part.

19. The computer-implemented method of claim 11, further comprising:
based upon the received data, identifying that the appliance or system requires maintenance; and
generating and transmitting a notification to the stakeholder, the notification including at least one of: a description of the appliance or system requiring maintenance, or instructions regarding how to perform the required maintenance.

20. At least one non-transitory computer-readable storage media having computer-executable instructions embodied thereon, wherein when executed by a computing device including at least one processor and at least one memory device, the computer-executable instructions cause the at least one processor to:
receive inputs corresponding to an issue related to an appliance or system, the inputs including at least one of: audio data, video data, or text data;
determine that the appliance or system is improperly functioning based on the received inputs;
identify an issue with the improperly functioning appliance or system including a part associated with the improperly functioning appliance or system that requires replacing or repairing;
present one or more recommendations to a user including options to fix the issue with the improperly functioning appliance or system; and
in response to an election by the user of a recommendation from the one or more recommendations, provide additional information to facilitate fixing the issue with the improperly functioning appliance or system.
